(19) United States
(12) Patent Application Publication
(10) Pub. No.: US 2023/0394841 A1
(43) Pub. Date: Dec. 7, 2023

(54) METHOD FOR ANALYZING THE SURROUNDINGS OF A MOTOR VEHICLE

(71) Applicant: ROBERT BOSCH GMBH, Stuttgart (DE)

(72) Inventor: Stefan Nordbruch, Leonberg (DE)

(21) Appl. No.: 18/245,760

(22) PCT Filed: Oct. 20, 2021
(86) PCT No.: PCT/EP2021/079043

§ 371 Date: Mar. 17, 2023

(30) Foreign Application Priority Data
Oct. 30, 2020 (DE) 10 2020 213 661.0

(51) Int. Cl. G06V 20/54; G06V 20/64

(52) U.S. Cl. CPC G06V 20/54; G06V 20/64

(57) ABSTRACT

A method for analyzing the surroundings of a motor vehicle. The surroundings are analyzed multiple times in order to determine multiple results in each case. Each of the multiple results indicates at least whether an object is located in the surroundings of the motor vehicle or not. It is determined, as an overall result, that an object is located in the surroundings of the motor vehicle if a majority of the multiple results indicates that an object is located in the surroundings of the motor vehicle. It is determined, as an overall result, that no object is located in the surroundings of the motor vehicle if a majority of the multiple results indicates that there is no object in the surroundings of the motor vehicle. A device, a system, a computer program, and a machine-readable storage medium are also described.

### FIELD

The present invention relates to a method for analyzing the surroundings of a motor vehicle. The present invention further relates to a device, a system for analyzing the surroundings of a motor vehicle, a computer program and a machine-readable storage medium.

### BACKGROUND INFORMATION

German Patent Application No. DE 10 2017 212 227 A1 describes a method or a system for vehicle data collection and vehicle control in road traffic.

German Patent Application No. DE 10 2018 101 487 A1 describes systems and methods for collision avoidance.

### SUMMARY

An object of the present invention is to provide efficient analyzing of the surroundings of a motor vehicle.

This object may be achieved by means of features of the present invention. Advantageous configurations of the present invention are disclosed herein.

According to a first aspect of the present invention, a method for analyzing the surroundings of a motor vehicle is provided, wherein the surroundings are analyzed multiple times in order to obtain multiple results which can in particular be referred to as individual results, wherein each of the multiple results indicates at least whether an object is located in the surroundings of the motor vehicle or not, wherein it is determined as an overall result that an object is located in the surroundings of the motor vehicle if a majority of the multiple results indicates that an object is located in the surroundings of the motor vehicle, wherein it is determined as an overall result that no object is located in the surroundings of the motor vehicle if a majority of the multiple results indicates that no object is located in the surroundings of the motor vehicle.

According to a second aspect of the present invention, a device is provided, which is configured to carry out all steps of the method according to the first aspect of the present invention.

According to a third aspect of the present invention, a system for analyzing the surroundings of a motor vehicle is provided, wherein the system comprises a plurality of surroundings sensors which are configured to acquire information about the surroundings of a motor vehicle, the system comprises the device according to the second aspect of the present invention.

According to a fourth aspect of the present invention, a computer program is provided, which comprises instructions that, when the computer program is executed by a computer, for example by the device according to the second aspect of the present invention and/or by the system according to the third aspect of the present invention, prompt said computer to carry out a method according to the first aspect of the present invention.

According to a fifth aspect of the present invention, a machine-readable storage medium is provided, on which the computer program according to the fourth aspect of the present invention is stored.

The present invention is based on and includes the insight that the surroundings of a motor vehicle are analyzed multiple times, in particular analyzed multiple times in parallel, wherein the individual results at least indicate whether an object is located in the surroundings of the motor vehicle or not, wherein these individual results are taken as the basis for obtaining an overall result which indicates whether an object is located in the surroundings of the motor vehicle or not. It is thus intended that the majority decides. Therefore, if the majority of the individual results indicate that one another object is located in the surroundings of the motor vehicle, the overall result is determined to be that no object is located in the surroundings of the motor vehicle. If the majority of the individual results indicate that an object is located in the surroundings of the motor vehicle, the overall result is determined to be that an object is located in the surroundings of the motor vehicle.

This, for example, may produce a technical advantage that the surroundings of a motor vehicle can be analyzed efficiently. This may, in particular, produce the technical advantage that the overall result is particularly trustworthy and reliable. For example, if one of the results incorrectly indicates that an object is located in the surroundings of the motor vehicle, this will not be reflected in the overall result if a majority of the multiple results correctly indicates that no object is located in the surroundings of the motor vehicle. The assumption is that it is more likely that a majority of the results will provide a correct result than the other way around. Errors in individual results can thus be efficiently compensated, so that a robust analysis of the surroundings of a motor vehicle is advantageously enabled.

According to one example embodiment of the present invention, it is provided that the multiple analysis of the surroundings is carried out using at least one of the following analysis means: different computer architectures, different programming languages, different analysis methods, in particular different developers of the analysis methods.

This, for example, may produce a technical advantage that a redundancy and/or a diversity can efficiently be created.

In one example embodiment of the present invention, it is provided that the multiple analysis of the surroundings is carried out using surroundings sensor data from different surroundings sensors that acquire information about the surroundings of the motor vehicle, in particular surroundings sensors from different manufacturers and/or surroundings sensors based on different sensor technologies.

This, for example, may produce the technical advantage that a redundancy and/or a diversity can efficiently be produced.

According to one example embodiment of the present invention, it is provided that the multiple analysis of the surroundings is carried out using surroundings sensor data from surroundings sensors that acquire information about the surroundings of the motor vehicle under different framework conditions.

This in particular may produce a technical advantage that there is a high probability that optimal framework conditions exist for the acquisition of information about the surroundings, so that there is an increased probability that the corresponding result is a correct result.

According to one example embodiment of the present invention, it is provided that the framework conditions include one or more elements of the following group of framework conditions: the respective position of the surroundings sensors, the respective viewing angle of the surroundings sensors, the light conditions.

This, for example, may produce a technical advantage that particularly suitable framework conditions can be selected. The light conditions, for example, indicate whether additional light was available to illuminate the surroundings. “Additional” here means in particular that artificial light, for example, was available.

According to one example embodiment of the present invention, it is provided that in each case that the multiple analysis of the surroundings is carried out using surroundings sensor data from surroundings sensors that acquire information about the surroundings of the motor vehicle, wherein a first analysis of the multiple analysis of the surroundings is carried out using a first analysis method and wherein a second analysis of the multiple analysis of the surroundings is carried out using a second analysis method, wherein the first analysis method includes a comparison of the respective surroundings sensor data with reference surroundings sensor data in order to detect a change in the surroundings of the motor vehicle, wherein it is determined that an object is located in the surroundings if a change has been detected, wherein the second analysis method is free from a comparison of the respective surroundings sensor data with reference surroundings sensor data.

This, for example, may produce a technical advantage that the surroundings can be analyzed efficiently. The first analysis method is therefore based on a so-called open space or free space monitoring. The reference surroundings sensor data therefore in particular provide a reference, which is thus known. Changes or deviations from this reference mean that there must be an object in the surroundings of the motor vehicle. An area that has been classified or defined as free according to the reference surroundings sensor data must include an object if, based on the surroundings sensor data, a change has been detected here. It is thus possible to efficiently identify whether an object is located in the surroundings of the motor vehicle.

The second analysis method is based on a direct object detection on the basis of the surroundings sensor data without a comparison with reference surroundings sensor data. The second analysis method includes the calculation of an optical flow, for example.

According to one example embodiment of the present invention, it is provided that the method according to the first aspect is a computer-implemented method.

According to one example embodiment of the present invention, it is provided that the method according to the first aspect is carried out by means of the device according to the second aspect and/or by means of the system according to the third aspect.

According to one example embodiment of the present invention, it is provided that the system according to the third aspect is configured to carry out all steps of the method according to the first aspect.

Method features result analogously from corresponding device and/or system features and vice versa. This means in particular that technical functionalities of the method according to the first aspect result from corresponding technical functionalities of the device according to the second aspect and/or from technical functionalities of the system according to the third aspect and vice versa.

According to one example embodiment of the present invention, the method according to the first aspect includes a respective acquisition of information about the surroundings of the motor vehicle by means of the surroundings sensors.

Surroundings sensor data in the sense of the description characterize or describe the surroundings of the motor vehicle.

In one example embodiment of the present invention, it is provided that the multiple analysis of the surroundings is carried out using surroundings sensor data from surroundings sensors that acquire information about the surroundings of the motor vehicle.

This, for example, may produce the technical advantage that the surroundings can be analyzed efficiently.

An example of a surroundings sensor in the sense of the description is one of the following surroundings sensors: radar sensor, LiDAR sensor, ultrasound sensor, magnetic field sensor, infrared sensor and video sensor.

According to one example embodiment of the present invention, a surroundings sensor is included in a motion detector.

According to one example embodiment of the present invention, it is provided that the plurality of surroundings sensors are distributed within an infrastructure, for example in a parking lot.

According to one example embodiment of the present invention, for example, the plurality of surroundings sensors are disposed in a spatially distributed manner, in particular disposed in a spatially distributed manner within the infrastructure, in particular within the parking lot.

The infrastructure includes one or more of the following infrastructures, for example: a parking lot, a traffic junction, in particular an intersection, a roundabout and/or a junction, a freeway on-ramp, a freeway off-ramp, an on-ramp in general, an off-ramp in general, a freeway, a country road, a construction site, a toll plaza and a tunnel.

According to one example embodiment of the present invention, it is provided that, based on the overall result, control signals for at least partially automated control of a lateral and/or longitudinal guidance of the motor vehicle are produced in order to drive the motor vehicle in an at least partially automated manner on the basis of the outputted control signals. According to one embodiment it is provided that the produced control signals are outputted.

According to one example embodiment of the present invention, it is provided that a lateral and/or longitudinal guidance of the motor vehicle is controlled in an at least partially automated manner based on the outputted control signals in order to drive the motor vehicle in an at least partially automated manner.

The phrase “at least partially automated driving” includes one or more of the following cases: assisted driving, partially automated driving, highly automated driving, fully automated driving.

Assisted driving means that a driver of the motor vehicle continuously carries out either the lateral or the longitudinal guidance of the motor vehicle. The respective other driving task (i.e., controlling the longitudinal or lateral guidance of the motor vehicle) is carried out automatically. This means that either the lateral or the longitudinal guidance is controlled automatically when the motor vehicle is driven in an assisted manner.

Partially automated driving means that in a specific situation (for example: driving on a freeway, driving within a parking lot, passing an object, driving within a travel lane defined by lane markings) and/or for a certain period of time, a longitudinal and a lateral guidance of the motor vehicle are controlled automatically. A driver of the motor vehicle does not have to manually control the longitudinal and lateral guidance of the motor vehicle himself/herself. However, the driver has to continually monitor the automatic control of the longitudinal and lateral guidance in order to be able to intervene manually when necessary. The driver has to be ready to take over complete control of the vehicle at all times.

Highly automated driving means that for a certain period of time in a specific situation (for example: driving on a freeway, driving within a parking lot, passing an object, driving within a travel lane defined by lane markings) a longitudinal and a lateral guidance of the motor vehicle are controlled automatically. A driver of the motor vehicle does not have to manually control the longitudinal and lateral guidance of the motor vehicle himself/herself. The driver does not have to continually monitor the automatic control of the longitudinal and lateral guidance in order to be able to intervene manually when necessary. If necessary, a take-over request is automatically issued to the driver to take over control of the longitudinal and lateral guidance, in particular issued with adequate time to spare. Thus, the driver has to potentially be able to take control of the longitudinal and lateral guidance. Limits of the automatic control of the lateral and longitudinal guidance are recognized automatically. In the case of highly automated driving, it is not possible to automatically bring about a minimal risk state in every starting situation.

Fully automated driving means that in a specific situation (for example: driving on a freeway, driving within a parking lot, passing an object, driving within a travel lane defined by lane markings) a longitudinal and a lateral guidance of the motor vehicle are controlled automatically. A driver of the motor vehicle does not have to manually control the longitudinal and lateral guidance of the motor vehicle himself/herself. The driver does not have to monitor the automatic control of the longitudinal and lateral guidance in order to be able to intervene manually when necessary. Before the automatic control of the lateral and longitudinal guidance is ended, the driver is automatically prompted to take over the driving task (control of the lateral and longitudinal guidance of the motor vehicle), in particular with adequate time to spare. If the driver does not take over the driving task, the system automatically returns to a minimal risk state. Limits of the automatic control of the lateral and longitudinal guidance are recognized automatically. In all situations, it is possible to automatically return to a minimal risk system state.

In one example embodiment of the present invention, some or all of the surroundings sensors are included in a motor vehicle. Surroundings sensors which are included in a motor vehicle can in particular be referred to as motor vehicle surroundings sensors. Surroundings sensors, which are included in an infrastructure or are spatially distributed within an infrastructure, in particular disposed in a spatially distributed manner, can be referred to as infrastructure surroundings sensors, for example.

In one example embodiment of the present invention, a device according to the second aspect and/or a system according to the third aspect is included in a motor vehicle or an infrastructure. In one embodiment, both the motor vehicle and the infrastructure respectively include a device according to the second aspect and/or a system according to the third aspect.

According to one example embodiment of the present invention, the method according to the first aspect is carried out by means of a motor vehicle.

According to one example embodiment of the present invention, it is provided that a communication message is produced which comprises the overall result. According to one embodiment, it is provided that the communication message is sent via a communication network, in particular via a wireless communication network, in particular to the motor vehicle.

The abbreviation “or” stands for “or”. The term “respectively” in particular includes the wording “and/or”. The term “or” in particular includes the term “respectively”.

According to one example embodiment of the present invention, it is provided that the plurality of results respectively indicate one or more object properties of the object if the respective result indicates that an object is located in the surroundings of the motor vehicle. Such an object property includes one of the following object properties, for example: length, size, width, weight, speed, acceleration, type, in particular pedestrian, motor vehicle, bicyclist, motorcycle, animal.

According to one example embodiment of the present invention, it is provided that the respective object properties of the relevant results are used to determine corresponding overall object properties, wherein, if the overall result indicates that an object is located in the surroundings of the motor vehicle, the overall result additionally provides the determined overall object properties. For example, it is provided that a respective average value based on the respective object properties is determined as the respective overall object properties.

In one example embodiment of the present invention, a number of individual results is an odd number. This in particular produces the technical advantage that the respective majority can be determined efficiently.

Embodiment examples of the present invention are shown in the figures and explained in more detail in the following description.

### BRIEF DESCRIPTION OF THE DRAWINGS

FIG. 1 shows a flowchart of a method for analyzing the surroundings of a motor vehicle, according to an example embodiment of the present invention.

FIG. 2 shows a device according to an example embodiment of the present invention.

FIG. 3 shows a system for analyzing the surroundings of a motor vehicle, according to an example embodiment of the present invention.

FIG. 4 shows a machine-readable storage medium, according to an example embodiment of the present invention.

FIG. 5 shows a road on which a motor vehicle is traveling, the surroundings of which are monitored by means of three surroundings sensors, according to an example embodiment of the present invention.

FIG. 6 shows a motor vehicle that is traveling on a road and the surroundings of which are monitored or sensed by means of six surroundings sensors, according to an example embodiment of the present invention.

FIGS. 7 and 8 each shows a respective different view of a motor vehicle prior to entering a tunnel, wherein the surroundings of the motor vehicle are sensed or monitored by means of six surroundings sensors, according to an example embodiment of the present invention.

In the following, the same reference signs can be used for the same features.

### DETAILED DESCRIPTION OF EXAMPLE EMBODIMENTS

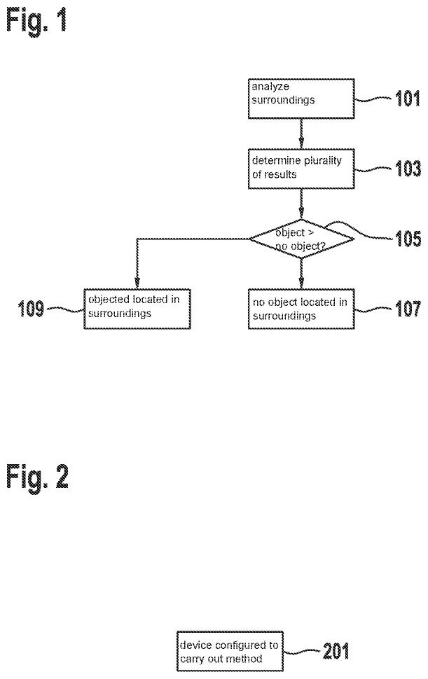

FIG. 1 shows a flowchart of a method for analyzing the surroundings of a motor vehicle.

According to a Step 101, it is provided that the surroundings are analyzed multiple times to determine a plurality of results according to a Step 103. The respective results of the multiple analyses can in particular be referred to as individual results. Each of the multiple results or individual results at least indicate whether an object is located in the surroundings of the motor vehicle or not.

According to a Step 105, a first number is determined, which indicates how many individual results indicate whether an object is located in the surroundings of the motor vehicle. In Step 105, a second number is further determined, which indicates how many individual results indicate that no object is located in the surroundings of the motor vehicle. The first number is compared to the second number. If the first number is greater than the second number, it is determined according to a Step 109 as an overall result that an object is located in the surroundings of the motor vehicle. If the second number is greater than the first number, it is determined according to a Step 107 as an overall result that no object is located in the surroundings of the motor vehicle. If the first number is equal to the second number, it is provided according to a not depicted embodiment that the method continues with Step 101. This means in particular that, in this case, the multiple analyses are repeated.

In other words, the majority decides. If more individual results indicate that an object is located in the surroundings of the motor vehicle, the overall result likewise indicates that an object is located in the surroundings of the motor vehicle. Conversely, that is if more individual results indicate that no object is located in the surroundings of the motor vehicle, the overall result likewise indicates that no object is located in the surroundings of the motor vehicle.

FIG. 2 shows a device 201 which is configured to carry out all steps of the method according to the first aspect.

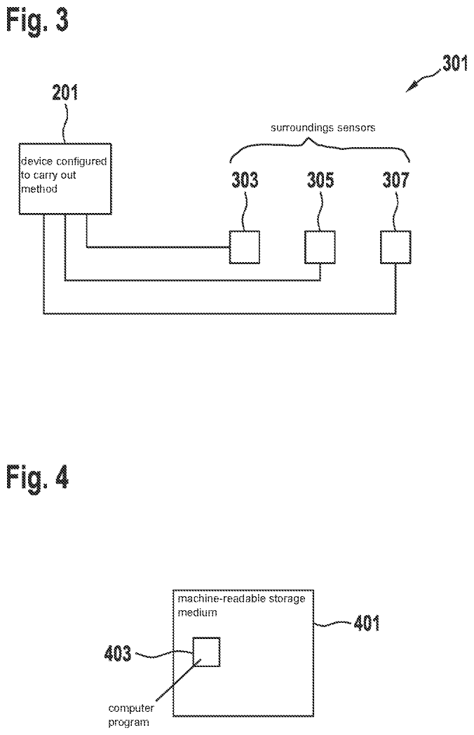

FIG. 3 shows a system 301 for analyzing the surroundings of a motor vehicle. The system 301 includes a plurality of surroundings sensors 303, 305, 307 each of which is configured to acquire information about the surroundings of a motor vehicle. The system 301 also comprises the device 201 of FIG. 2.

When carrying out the method according to the first aspect according to one embodiment, the plurality of surroundings sensors 303, 305, 307 acquire information about the surroundings of the motor vehicle and provide surroundings sensor data corresponding to said acquisition to the device 201. Based on the surroundings sensor data, it is provided according to one embodiment that the surroundings of the motor vehicle are analyzed multiple times.

In a not depicted embodiment, it is provided that one or more or all of the multiple analyses of the surroundings can be carried out using one or more or all of the surroundings sensors 303, 305, 307. This means that the respective analysis is carried out in the surroundings sensors, for example by means of a processor of the respective surroundings sensor.

In a not depicted embodiment, instead of or in addition to the above-described surroundings sensor-internal analysis of the surroundings, it is provided that one or more or all of the multiple analyses of the surroundings are carried out in downstream, i.e., in particular separate from the surroundings sensors, calculation units or analysis units. This means, for example, that the surroundings sensor(s) 303, 305, 307, in particular only, provide the surroundings sensor data, wherein at least one not depicted calculation unit or analysis unit, which is assigned to or downstream of the respective surroundings sensors 303, 305, 307, for example, carries out the corresponding analysis of the surroundings.

FIG. 4 shows a machine-readable storage medium 401, on which a computer program 403 is stored. The computer program 403 comprises instructions that, when the computer program 403 is executed by a computer, prompt said computer to carry out a method according to the first aspect.

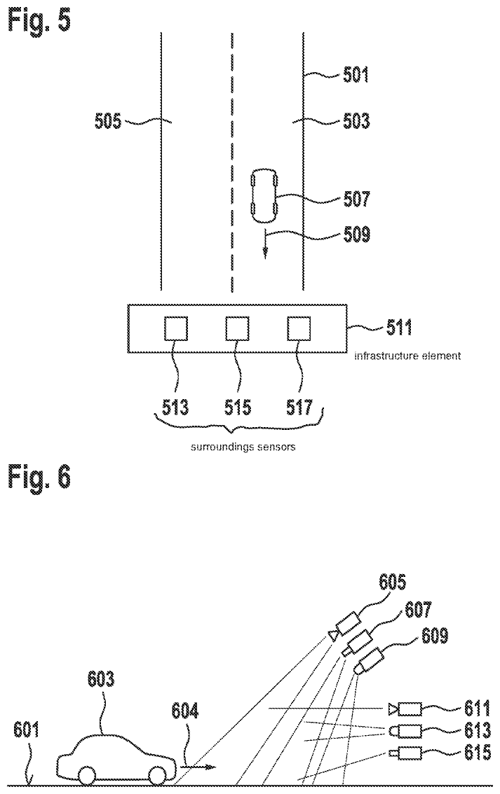

FIG. 5 shows a two-lane road 501 comprising a first travel lane 503 and a second travel lane 505. A motor vehicle 507 is traveling in the first travel lane 503. A direction of travel of the motor vehicle 507 is indicated by an arrow with the reference sign 509.

The surroundings of the motor vehicle 507 are monitored or sensed by means of a first surroundings sensor 513, a second surroundings sensor 515 and a third surroundings sensor 517. The three surroundings sensors 513, 515, 517 are disposed on an infrastructure element 511. The infrastructure element 511 is disposed above the road 501, for example.

In one embodiment, the three surroundings sensors 513, 515, 517 are different. The first surroundings sensor 513 is a radar sensor, for example, the second surroundings sensor 515 is a video sensor, for example, and the third surroundings sensor 517 is an infrared sensor, for example.

The surroundings sensor data of the first surroundings sensor 513 is analyzed using a first analysis method, for example, and the surroundings sensor data of the second surroundings sensor 515 is analyzed using a second analysis method, for example, and the surroundings sensor data 517 is analyzed using a third analysis method, for example, wherein all three analysis methods are different from one another.

According to one embodiment, for example, it is provided that the three surroundings sensors 513, 515, 517 are identical, but the respective surroundings sensor data are analyzed or evaluated using different analysis methods.

According to one embodiment, for example, it is provided that the respective surroundings sensor data of the three surroundings sensors 513, 515, 517 are evaluated or analyzed using a same analysis method, but the three surroundings sensors 513, 515, 517 are different.

According to one embodiment, for example, it is provided that the surroundings sensor data of the three surroundings sensors 513, 515, 517 are analyzed or evaluated on different computer architectures.

According to one embodiment, for example, it is provided that the analysis methods used to analyze the surroundings sensor data of the three surroundings sensors 513, 515, 517 are from different developers. According to one embodiment, for example, it is provided that the analysis methods are written in different programming languages.

According to one embodiment, any combination of the above-described embodiments are disclosed or provided.

FIG. 6 shows a road 601 on which a motor vehicle 603 is traveling. A direction of travel of the motor vehicle 603 is indicated by an arrow with reference sign 604.

Six surroundings sensors are provided: a first surroundings sensor 605, a second surroundings sensor 607, a third surroundings sensor 609, a fourth surroundings sensor 611, a fifth surroundings sensor 613 and a sixth surroundings sensor 615.

The three surroundings sensors 605, 607, 609 form a first group of surroundings sensors. The surroundings sensors 611, 613, 615 form a second group of surroundings sensors.

The six surroundings sensors 605 to 615 monitor, or acquire information about, the surroundings of the motor vehicle 603.

According to one embodiment, it is provided that the respective surroundings sensor data of the surroundings sensors 605 to 609 of the first group are compared to the reference surroundings sensor data, wherein, if a change in the surroundings of the motor vehicle is identified, it is determined on the basis of the comparison that an object is located in the surroundings of the motor vehicle. If no change is detected, it is determined that no object is located in the surroundings of the motor vehicle.

According to one embodiment, the surroundings sensor data of the surroundings sensors 611 to 615 of the second group is analyzed or evaluated using an analysis method or multiple analysis methods, wherein these analysis methods are free from a comparison of the respective surroundings sensor data with reference surroundings sensor data. This means that the analysis of the surroundings sensor data of the first group is based, among other things, on monitoring a known open space in a known world. A change to the known open space means that something has to be there that was not there before, so it is assumed that an object must now be located in the open space. A LiDAR system or video sensor of a video camera captures a floor or a wall, for example, wherein a change to the known wall or floor is used to detect that something, in particular an object, must have entered or traveled into this area. The change can include a pattern, for example, and/or a changed distance to the floor or to the wall.

According to one embodiment, the analysis methods for analyzing the surroundings sensor data of the second group are based on searching for objects in an unknown world, for example across contiguous areas.

Combining the two above-described approaches has the effect, in particular advantageously, that advantages of both approaches can be combined with one another, wherein, for example, respective disadvantages of the two approaches can advantageously be efficiently compensated.

One advantage of the first approach is that changes can be detected efficiently, for example, so that, correspondingly, it is possible to efficiently determine that an object must be located in the surroundings of a motor vehicle. One disadvantage, for example, is that it is difficult to classify the object, i.e., whether it is a motor vehicle, a human or a bicycle.

One advantage of the second approach, for example, is that a detected object can be classified efficiently, so that the disadvantage of the first approach can be compensated efficiently.

One disadvantage of the second approach, for instance, is that the corresponding surroundings sensor can have an error, for example, so that it is difficult to determine whether a detected object actually corresponds to a real object. But this disadvantage can advantageously be efficiently compensated by the first approach.

Advantages can thus in particular be seen in the fact that combining these two approaches uses two technologically different approaches, which increases the probability that the environment or the surroundings have been analyzed correctly, while objects can furthermore be classified efficiently.

According to one embodiment, for example, it is provided that the surroundings sensors of the first group sense the surroundings of the motor vehicle 603 from a different viewing angle than the surroundings sensors of the second group. In one embodiment, it is provided that a respective viewing angle is the same.

The surroundings sensors of one group can be aligned longitudinally along the road 601, for example, and/or the surroundings sensors of the other group can be aligned transverse to the road 601.

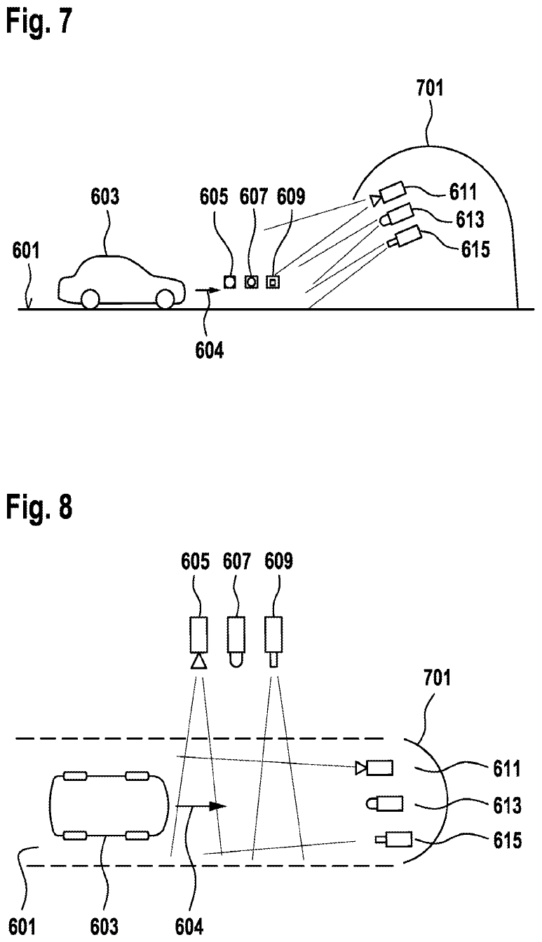

FIG. 7 shows a side view of a comparable scene compared to FIG. 6 which additionally schematically shows a tunnel 701 in a side view, wherein the motor vehicle 603 is traveling in the direction of the tunnel 701.

FIG. 8 shows a corresponding plan view onto the scene according to FIG. 7.

In summary it can be said that the here-described concept in particular provides a surroundings analysis approach that is safe. This means in particular that the overall result can be trusted with a very high probability.

In one embodiment it is provided that the method is used to support at least partially automated motor vehicles. For example, at least partially automated motor vehicles are supported during an at least partially automated guided trip within an infrastructure. This means, for instance, that a scene in the infrastructure is analyzed using the method according to the first aspect, and the overall result is provided to the motor vehicle, for example, so that the motor vehicle can plan and carry out its driving task based on the overall result.

The infrastructure includes, for example, a tunnel, a freeway on-ramp, a freeway off-ramp, an intersection, a construction site, a roundabout, a junction in general, a parking lot. Thus, for example, complex and difficult situations, such as entering/passing through/exiting a tunnel, entering a freeway, in particular with merging into traffic on the freeway, passing through intersections and driving through construction sites, can advantageously be managed efficiently.

In one embodiment, it is provided that the here-described concept is also used in a control of one or more robots.

In one embodiment, it is provided that the method according to the first aspect is carried out in the motor vehicle itself. This means, for example, that the surroundings sensors can be included in the motor vehicle.

The here-described concept is based in particular on the fact that an analysis is carried out using a plurality of different sensor technologies (LiDAR, video, radar, ultrasonic, motion detector, etc.) and/or evaluation approaches or analysis methods (free space monitoring, object detection, optical flow, etc.) and/or different framework conditions (for example, positions and/or viewing angles of the surroundings sensors) and/or different implementations of the surroundings sensors and/or different implementations of the analysis methods.

This means in particular that a scene or the surroundings of a motor vehicle is analyzed multiple times, in particular in parallel.

The individual results are in particular used to arrive at a greater-than-50% decision, in particular taking deviations into account. This means in particular that, in the case of three surroundings sensors and/or approaches, the result that has been determined at least twice is used. Or, for example, at least three out of five, at least four out of seven, at least five out of nine, etc. It is in particular provided that there is always an odd number of individual results. This means in particular that the surroundings are analyzed multiple times, wherein the respective number is odd.

According to one embodiment, it is provided that surroundings sensor data of a surroundings sensor is analyzed using three or an odd number of different analysis methods, for example object detection, free space monitoring, optical flow.

In one embodiment, it is provided that an odd number of different sensor technologies, for example radar, video, LiDAR, infrared, magnetic field, is used with one or two or three different analysis methods, for example object detection, optical flow, free space monitoring, to analyze or evaluate the respective surroundings sensor data.

In one embodiment, it is provided that a sensor technology, for example video, is provided, wherein the respective surroundings sensor data is evaluated using three different evaluation methods or analysis methods.

In one embodiment, it is provided that that two sensor technologies, for example radar and video, are provided, wherein the respective surroundings sensor data is used with three different evaluation methods, for example an evaluation method for the surroundings sensor data of the radar sensor and two evaluation methods for the surroundings sensor data of the video sensor, so that a number of the individual results is three (different calculation) with additional diversity being provided by the diversity sensors or hardware.

In one embodiment, every possible combination of the above-described embodiments is disclosed or provided.

A further increase in trustworthiness, more diversity in particular means increased safety, is advantageously achieved, for instance, if the evaluation methods or algorithms are implemented differently, for example by different developers, in different programming languages, which is provided according to one embodiment. The respective analyses are in particular carried out on different computer hardware or computer architectures.

A further increase in trustworthiness can be achieved, for example, if the same surroundings sensors or sensor technologies are used by different manufacturers, which is provided according to one embodiment.

A further increase in trustworthiness is advantageously achieved if a scene or the surroundings is sensed from different positions or viewing angles, for example from the front, from the side, from above or from the rear, which is provided according to one embodiment.

One advantage of the here-described concept is in particular that the overall result is “safe” with a very high probability, i.e., safe in the sense of being trustworthy. This is a requirement or basis if the overall result is to be used for a safety-relevant action, for example at least partially automated control of a lateral and/or longitudinal guidance of a motor vehicle.

The core of the here-described concept can therefore in particular be seen in the fact that the result taken from the sum of the individual results determined, in particular in parallel, as the overall result is the result which was determined by more than 50%, i.e., by the majority.

In one embodiment, it is provided that the individual results are determined using different sensor technologies (redundancy and/or diversity) and/or different evaluation methods (redundancy and/or diversity) and/or different implementations of the surroundings sensors (for example video sensors from different manufacturers) and/or different implementations of the evaluation methods and/or analysis methods (for example different developers, different computer architectures, different programming languages) and/or different framework conditions (for example position, viewing angle, additional light).

1-10. (canceled)

11. A method for analyzing surroundings of a motor vehicle, comprising the following steps:
analyzing the surroundings multiple times to obtain multiple results, each of the multiple results indicating at least whether an object is located in the surroundings of the motor vehicle or not; and
determining as an overall result that an object is located in the surroundings of the motor vehicle based on a majority of the multiple results indicating that an object is located in the surroundings of the motor vehicle, and determining as the overall result that no object is located in the surroundings of the motor vehicle based on a majority of the multiple results indicating that no object is located in the surroundings of the motor vehicle.

12. The method according to claim 11, wherein the multiple analysis of the surroundings is carried out using at least one of the following analysis arrangements: different computer architectures, different programming languages, different analysis methods, different developers of the analysis methods.

13. The method according to claim 11, wherein each of the multiple analysis of the surroundings is carried out using surroundings sensor data from different surroundings sensors that acquire information about the surroundings of the motor vehicle, the different surrounding sensors being surroundings sensors from different manufacturers and/or surroundings sensors based on different sensor technologies.

14. The method according to claim 11, wherein each of the multiple analysis of the surroundings is carried out using surroundings sensor data from surroundings sensors that acquire information about the surroundings of the motor vehicle under different framework conditions.

15. The method according to claim 14, wherein the framework conditions include one or more elements of the following group of framework conditions: a respective position of the surroundings sensors, a respective viewing angle of the surroundings sensors, light conditions.

16. The method according to claim 12, wherein each of the multiple analysis of the surroundings is carried out using surroundings sensor data from surroundings sensors that acquire information about the surroundings of the motor vehicle, wherein a first analysis of the multiple analysis of the surroundings is carried out using a first analysis method and wherein a second analysis of the multiple analysis of the surroundings is carried out using a second analysis method, wherein the first analysis method includes a comparison of respective surroundings sensor data with reference surroundings sensor data to detect a change in the surroundings of the motor vehicle, wherein it is determined that an object is located in the surroundings when a change has been detected, and wherein the second analysis method is free from a comparison of respective surroundings sensor data with reference surroundings sensor data.

17. A device configured to analyze surroundings of a motor vehicle, the device configured to:
analyze the surroundings multiple times to obtain multiple results, each of the multiple results indicating at least whether an object is located in the surroundings of the motor vehicle or not; and
determine as an overall result that an object is located in the surroundings of the motor vehicle based on a majority of the multiple results indicating that an object is located in the surroundings of the motor vehicle, and determining as the overall result that no object is located in the surroundings of the motor vehicle based on a majority of the multiple results indicating that no object is located in the surroundings of the motor vehicle.

18. A system configured to analyze surroundings of a motor vehicle, comprising:
a plurality of surroundings sensors, each of the surroundings sensors being configured to acquire information about the surroundings of the motor vehicle; and
a device configured to:
analyze the surroundings multiple times to obtain multiple results, each of the multiple results indicating at least whether an object is located in the surroundings of the motor vehicle or not; and
determine as an overall result that an object is located in the surroundings of the motor vehicle based on a majority of the multiple results indicating that an object is located in the surroundings of the motor vehicle, and determining as the overall result that no object is located in the surroundings of the motor vehicle based on a majority of the multiple results indicating that no object is located in the surroundings of the motor vehicle.

19. A non-transitory machine-readable storage medium on which is stored a computer program for analyzing surroundings of a motor vehicle, the computer program, when execute by a computer, causing the computer to perform the following steps:
analyzing the surroundings multiple times to obtain multiple results, each of the multiple results indicating at least whether an object is located in the surroundings of the motor vehicle or not; and
determining as an overall result that an object is located in the surroundings of the motor vehicle based on a majority of the multiple results indicating that an object is located in the surroundings of the motor vehicle, and determining as the overall result that no object is located in the surroundings of the motor vehicle based on a majority of the multiple results indicating that no object is located in the surroundings of the motor vehicle.
